(19) United States
(12) Patent Application Publication
(10) Pub. No.: US 2007/0272775 A1
(43) Pub. Date: Nov. 29, 2007

(54) Method for Processing Plastic Waste to Obtain Matrix Material; the Matrix Material and the Composite Material

(76) Inventors: Mihaly Szilvassy, Ercsi (HU); Miklos Nemeth, Budapest (HU)

Correspondence Address: HERSHKOVITZ & ASSOCIATES, 2845 DUKE STREET, ALEXANDRIA, VA, 22314, US

(21) Appl. No.: 11/631,653

(22) PCT Filed: Jun. 3, 2005
(86) PCT No.: PCT/HU05/00059

§ 371 Date: Jan. 5, 2007

(30) Foreign Application Priority Data
Jun. 7, 2004 (HU) P-04-01134

(51) Int. Cl. B02C 19/00; B02C 11/08; B02C 21/00

(52) U.S. Cl. 241/3; 241/23; 241/65

(57) ABSTRACT

A method for producing matrix material from thermoplastic wastes originating from communal and industrial rubbish. According to the method: a) the base material plastic waste is primary cleaned if necessary, depending on its solid contamination; b) after the possible primary cleaning step if necessary, the plastic waste is inputted into a recovering machine, where due to the pressure in the recovering machine and the heat transmitted to the material, the waste becomes a largely melted, nearly homogeneous and mostly fused mixture; c) the largely melted mixture is transferred into a heated internal mixing machine where the material is intensively mixed while adding heat; and d) if required, the melted material is transferred into a making-up machine, where matrix material blocks or matrix material products are produced. The invention relates also to the matrix material and the composite material produced from the matrix material.

### BACKGROUND OF THE INVENTION

1. Field of the Invention

The invention resides in a method for processing plastic waste to obtain matrix product having wide-ranging uses mainly from contaminated thermoplastic wastes that can not be utilized for any other purpose, and further processing of this matrix material by adding filling materials to obtain composite material for technical use, primarily as a building material.

### SUMMARY OF THE INVENTION

Aspects of this disclosure include a method for producing matrix material from thermoplastic waste originating from communal and industrial rubbish with one of, (a) melting of the waste and transferring the melted plastic material to a homogenizing machine, and (b) melting of the waste and transferring the melted plastic material to a homogenizing machine with making-up of the melted material, the method further comprising inputting communal and industrial rubbish into a recovery machine equipped with heat transfer surfaces without selection, primary cleaning, chopping or shredding, impurely and in dry condition, where the plastic content of the rubbish mostly becomes a largely melted, nearly homogenous mixture by the help of the simultaneous effect of pressure and heat transmitted to the material where the pressure is between 0.5×10⁷ Pa and 2.5×10⁷ Pa and a heating temperature is between 200° C. and 280° C. and transferring the largely melted mixture into a heated internal mixing machine at a temperature between 200° C. and 260° C. without extrusion where complete melting and homogenization is carried out by the help of intensive mixing and heat transmission but without any of at least one of networking material and networking treatment, wherein a matrix material is obtained.

According to other aspects of the invention, the method can further comprise inputting the dry waste at a temperature between 20° C. and 50° C. into the recovery machine. The pressure can be 1.2×10⁷ to 1.6×10⁷ Pa . The heating temperature can be between 240° C. and 280° C. The largely melted material leaving the recovery machine into the internal mixing machine can be inputted at a temperature between 250° C. and 270° C. A pressed product can be formed from melted matrix material originated in the internal mixing machine by heat and pressure. A composite material can be produced from the matrix material with suitable filling material but without, at least one of, any networking material and networking treatment, wherein the filling material is added to the melted matrix material, and the composite material final product is obtained by mixing and heating. The molded product can be cooled under pressure. Organic material can be inputted as filling material. Agricultural and manufacturing industrial organic material can be inputted as organic filling material including leather wastes. Inorganic material can be inputted as filling material. One can input at least one of car tire granulate including cord fibers, wastes of steel rims treated with rubber or glass, and thermosetting plastic scrapings as inorganic industrial waste filling material and inputting at least one of earth, brick dust, pebbles, crushed rocks, granite, limestone and andesite as mineral filling material.

According to another aspects of the invention, composite material produced from matrix material can comprise from 10% to 95% unclean inorganic waste as filling material including at least one of earth, metal, and crushed mineral material, crushed brick, stone, granite, limestone, marbles and andesite. Pressed material can be formed from the matrix material. Composite material can be produced from the matrix material with suitable filling material but without, at least one of, any networking material and networking treatment, wherein the filling material is added to the melted matrix material, and the composite material final product is obtained by mixing and heating, and, forming a final product by pressing to achieve a molded product of a required shape. A matrix material can be produced by the above-described method.

According to another aspect of the invention, there is provided an apparatus for utilization in a method for producing matrix material from thermoplastic waste originating from communal and industrial rubbish with one of, (a) melting of the waste and transferring the melted plastic material to a homogenizing machine, and (b) melting of the waste and transferring he melted plastic material to a homogenizing machine with making-up of the melted material. The apparatus comprises a recovery machine configured for inputting communal and industrial rubbish into the recovery machine, the recovery machine equipped with heat transfer surfaces without selection, primary cleaning, chopping or shredding, impurely and in dry condition, where the plastic content of the rubbish mostly becomes a largely melted, nearly homogenous mixture by the help of the simultaneous effect of pressure and heat transmitted to the material where said pressure is between 0.5×10⁷ Pa and 2.5×10⁷ Pa and a heating temperature is between 200° C. and 280° C. A heated internal mixing machine is configured for transferring the largely melted mixture into the heated internal mixing machine at a temperature between 200° C. and 260° C. without extrusion where complete melting and homogenization is carried out by the help of intensive mixing and heat transmission but without any of at least one of networking material and networking treatment, wherein a matrix material is obtained from the apparatus.

According to yet another aspect of the invention, a pressed product is obtained from the above-described apparatus.

Further objects of the invention are the matrix product obtained as a result of the plastic waste processing, and the composite material of technological use, primarily building materials, produced by adding the filling materials. The methods according to the invention do not include a chopping step.

Disposal and recycling of plastic wastes is an unsolved problem these days. Production and usage of plastics is continuously increasing, resulting in an increasing amount of plastic wastes as well.

Plastic wastes can be classified in three groups:

1) Technological wastes, manufacturing wastes, and processing wastes. Such wastes usually do not get into the environment. They can be recycled into the manufacturing process directly, or after chopping and crushing.

2) Industrial wastes, further processing wastes, and confectioning wastes. Such wastes are usually produced in the course of processing and confectioning the plastic semifinished products at the place of application. They are of a homogeneous type, clean, and their utilization is usually solved: they are either repurchased by the manufacturers of the semifinished products, or purchased by companies specializing in waste recycling.

3) Wastes of plastic products after they have been used, packaging materials, hollow articles, and used products. This latter category of plastic wastes causes the most significant problem.

Recycling of plastic wastes placed at garbage chutes is an issue of key importance all over the world. The properties of plastics that are advantageous when they are used—e.g. they do not decompose due to external environmental effects, they do not become rotten, and they are of low density and high specific volume—become disadvantageous when they get to the garbage chute. Despite the fact that about 10% of household rubbish is plastic, and that 1.5% of the total rubbish placed at garbage chutes contain building rubbish as well as plastic, it seems to be much more, as it has a high volume to its mass.

Due to their special physical and chemical properties, reusing and especially recycling of plastics requires a novel approach.

In the frame of selective waste collection, plastics from public use of different polymer matrix are collected in one group as “plastics”, irrespective of what these plastics are actually made of.

A further problem of recycling is that there may be hundreds of variants or, in the case of certain volume-produced plastics, even thousands of variants within a single, type of plastic. Even the recycling of plastics sorted by type may cause difficulties if they are not used for the same purpose, e.g. polyethylene used for injection moulding is not the same as polyethylene developed for pipe production or bottle-blowing. Intermingling of plastics in the course of selective waste collection further reduces their usability. It especially encumbers the recycling of wastes comprising plastics of different chemical structure.

Utilization of miscellaneous plastic wastes is a critical issue these days. It is usually considered these days that technical depreciation inevitably takes place in the course of recycling, and as a result, the recycled plastic can only be applied for purposes of a lower standard.

Contaminated and miscellaneous wastes—according to the present state of the art—can not usually be economically recycled, and their utilization requires new methods. The more contaminated and miscellaneous the plastic waste to be prepared for recycling is, the more expensive the preparation is. This is especially true for the plastic content of highly miscellaneous, highly contaminated household wastes originating from consumer packaging, even if it is coming from selective waste collection.

From another aspect, the serious problem of management and/or disposal of communal wastes is made even more difficult by plastic wastes, as due to their shape (mainly foils, foams, bags, and bottles) and low specific weight they can be carried by the wind, they do not, or hardly, decay in a biological way, and they increase the cubic content of rubbish. Disposal of these plastic wastes and especially the compression thereof is of primary interest in itself. However, it is especially advantageous if they can be used for producing useful products that can substitute for other materials of technological use, especially wood, that can only be obtained from nature.

The object of the present invention with the methods according to the invention is:
a) to produce matrix material from useless plastic waste, which is useful in itself and can also be further processed,
b) to apply a further step to produce technologically useful composite material that can preferably substitute for building materials and wood, and this way
c) to remove material of low specific weight and high cubic content from the wastes.

As regards the final products of the method, the pure material (free of additives), which is referred to as matrix material so as to make a distinction, is differentiated from the material containing filling materials, which is obtained from the pure matrix material by adding filling materials, and is referred to as composite material. Composite materials comprising thermoplastics and filling materials have been prepared and used for decades, however, in the traditional processing equipment, it is a requirement that the plastics to be processed must be clean. Therefore with these methods one can process either new thermoplastics or plastics obtained from accurate selective waste collection after thorough separation and cleaning. In Hungary only about 15% of the plastic wastes can be collected for reprocessing via selective waste collection and industrial recycling these days. And even of this 15% only the cleanest, most valuable part is recycled, the remainder is placed embaled at the trash chutes, increasing the pollution of the environment. In lack of appropriate processing technology, in spite of the well- founded social demand, and primarily due to lack of money, there is not even that much hope for the processing of the remaining 85% and the utilization of its plastic content.

In the course of the traditional methods, the first step of processing the plastic wastes to be utilized is selecting and chopping. Besides the significant energy consumption of chopping there are technical difficulties as well. Foils may slip near the knives, and even the smallest metal pieces may cause the blades to break or damage the entire machine, while fibrous plastics (cords) may roll onto the shafts of rotating parts. Therefore the step of chopping should be avoided as a first step of processing of contaminated heterogeneous plastics.

As the second step of traditional methods the chopped waste “crushing” (which, as we have mentioned, can primarily be gained from expensive and accurately selected, relatively clean base material, with difficulties and high energy consumption) is homogenized while it is heated in a mixing process, in certain cases with filling materials added, then this material is injection moulded or extruded to obtain its final form in a shaping tool.

The matrix material thus obtained or the composite material obtained with the filling materials added easily breaks into its components upon mechanical stress, so its applicability is quite limited. These methods are in fact suitable for compression of certain plastic wastes. However, the other object, the production of useful material substituting for natural material is not satisfactorily solved. Therefore there is a need for a novel method that performs the above described functions significantly cheaper and more effectively.

Several other methods have been suggested to solve the problem, which is proven by the large number of patents registered in this technical field. However, these patents do not imply the method according to the present invention. There is not even one patent closely related to the present solution. However, three patents that have shallow resemblance to the present method are mentioned.

According to the method of the Canadian patent No. CA 2365772 (Barcheno Juan Carlos) the plastic waste is processed without separation and washing. The plastic wastes are processed in a bladed mill with simultaneous heating at a temperature of maximum 300° C., then the mass is extruded.

US patent No. U.S. Pat. No. 5,746,958 (TREX Company) presents a method where a mixture of wood waste and thermoplastic waste is produced, this mixture is pelleted afterwards, and the pelleted mixture as a base material can be then used for several purposes. Both the wood waste and the plastic waste are crushed into small pieces, and the pelleting also takes place in a mill.

US patent No. U.S. Pat. No. 5,851,469 (TREX Company) presents a method where a mixture of heated plastic mass and wood grinds is produced, and this is pressed hot through an extrusion hole, then the strip-like material is allowed to stand, treated and cooled. This method requires that the plastics should be carefully selected based on their melting point, with an upper limit of 150° C. The raw material is thermoplastic melted without chopping.

The above mentioned patent descriptions include certain steps of the method according to this invention. However, they also include steps that are actually eliminated by this invention, and the combination of the methods according to the invention can not be found in the closest prior art. The special purpose equipment of the first step of this invention, the recovering machine is also novel.

### DETAILED DESCRIPTION OF THE PRESENT INVENTION

In what follows, the method according to this invention is presented.

The basic material of the waste processing method is thermoplastic gained from industrial and communal wastes, which can originate from selective waste collection and from the part of the industrial wastes that can not be utilized elsewhere. The following can be examples for the basic materials, without making any restriction:
miscellaneous foil type materials of any thickness, painted or otherwise contaminated,
threads, cords or other plastic fiber-like products or products made of these fibers made of any raw material, plastic fabric, e.g. the material of big-bag sacks or wastes originating from the production thereof,
communal composite plastic waste, milk bags, bottles, polyethylene sacks etc. and other miscellaneous plastic wastes contaminated with food,
mulch foils and strips used in agriculture, plastic bags used with mushroom growing,
plastic bottles with paper “contamination” (bottle-labels), irrespective of what had been originally stored in it,
plastic boxes used for transportation purposes, partition boxes, barrels, cans, irrespective of what had been originally stored in it (except for toxicants), sanitary towels, napkins, other miscellaneous sanitary packaging material,
PVC sheets, drainage pipes, miscellaneous contaminated PVC wastes, building plastic wastes,
polystyrene; housings, production wastes and insulation of electrical products.

It can be seen that the basic materials of the method are of quite varying types. The only important point is that the amount of thermoplastics in the processed material should be enough for the following technological steps.

In the plastic content of industrial and communal wastes the major part is polyethylene and polypropylene, but it also contains polystyrene, different kinds of polyamides, PVC and other thermoplastic wastes as well.

If the raw material is a mixture of plastic wastes and other rubbish, it is advisable to perform a primary cleaning and selection step prior to applying the method according to the invention. The purpose of this physical cleaning is to ensure safe operation of the machinery applied in the process. The method is not at all sensitive to the cleanliness of the material processed, that is, there is no need for so clean basic material as is necessary in the methods according to the prior art. The aspects of the primary cleaning step are as follows: the physical size of the contaminating material should be smaller than the feeding hole, and these contaminating materials should not damage the recovering machine. Therefore the large solid pieces must be manually removed. It may be done partly manually and partly via electromagnetic metal removal. Shakers can be applied as further primary cleaning apparatuses.

Water content of the base material is a disadvantage. It is especially disadvantageous if the water content is more than 8% of the mass of the input base material. Though the water content is evaporated during the processing, the vapor may condense at other, cold parts of the equipment, which increases the processing time. Therefore it is recommended that the base material waste should be pre-heated. Pre-heating eliminates moisture, and the heat inputted in the course of pre-heating is utilized in the next step.

In order to avoid significant loss of heat, it is advantageous that the temperature of the material inputted into the recovering machine should be at least 20° C. This temperature can be more, even 50° C. However, the highest temperature must not exceed the melting temperature of the plastic waste of the lowest melting point.

The primary selected material gets into the recovering machine. The material is melted here by heating and applying pressure. This apparatus applies no rotational, cutting, drying, slicing or chopping procedure. The only moving part of the apparatus is the press. This is a continuous operation equipment. The pressure, which is required for melting the plastic waste is between 10⁴ and 3.0×10⁷ Pa (0.1-300 kg/cm²), preferably 2.4×10⁷ Pa (240 kg/cm²). The pressure presses the material against the warm heat transferring surface, so the heat transferred by the surface can be optimally utilized. At this pressure, the heat transferred by the heat transferring surfaces is enough for the recovering and melting of the miscellaneous plastic waste. The effective pressure depends on the content and composition of the inputted waste.

As the composition of the waste is varying, i.e. it is a mixture of different type plastic wastes in different proportions, the melting point of the composite material inputted can not be determined. The basic idea is that, as a result of the technical process, the HBD (high bulk density) of the plastic waste should be increased to at least 0.5 kg/dm³ volume density. The temperature of the heat transferring surface is between 240° C. and 300° C., preferably between 250° C. and 280° C., most preferably it is 270° C.

It is not essential for the process that all the materials reach their melting temperature. The goal is that the cubic content of the composite waste should be significantly reduced, and the material thus obtained could be smoothly transferred to the next step. It can be judged by ocular inspection, based on practical experience.

The temperature of the material melted by the pressing and heating is between 130° C. and 290° C., preferably it is 240° C. The material is transferred to the internal mixing machine at this temperature.

The material pressed out from the recovering machine is partly or entirely melted. This material is not completely homogeneous, and it may segregate, disintegrate after cooling down just like the matrix materials obtained by the prior art methods. Therefore its only the next obligatory step of the processing technology that ensures the production of the matrix material according to the invention. This step is the internal mixing in an appropriate machine, which, combined with the previous step, radically changes the technology of recycling plastic wastes.

The internal mixing machine applied in the method according to the invention mixes the material and exposes it to shear and compression stress in a way that the material is rearranged at the molecular level, some old molecular links are broken, while new molecular links are established between the different materials. The material leaving the previous step, i.e. the recovering process, which is not perfectly recovered, gets directly in to the internal mixing machine. This machine is an intermittent-operation machine that homogenizes the material by adding heat, and ensures perfect extraction of the melted material from the machine at the end of the process.

It is important that the temperature in the internal mixing machine must not exceed the temperature that may lead to deterioration of the material. This is determined experimentally by watching the temperature and the consistence of the material.

The material obtained at the end of this process is already a matrix product according to the invention in its melted form, which also acts as a basis of the next technological step in which filling materials are added to obtain composite materials.

From the mixing machine the melted matrix material gets into the making-up machine, the tool of which can be a pressing machine, an injection mould, a transfer moulding machine, a calender or an extruder. The pressed matrix material can be a product in itself, and it can also act as a base material of composite materials obtained by adding filling materials to it.

In a typical example the melted material gets into a closed press which is designed to have the form of the final product, and the product cools down and obtains its final form in it. In order to avoid deformation and piping, the pressure must be maintained until the end of the cooling process.

The thus obtained matrix material that has gone through the technological steps of recovering, mixing and hot-pressing in the course of processing, is a chemically stable material of special physical properties, it is compression resistant and has high tear resistance, and it can be manually worked or machined. Its density is preferably between 0.6-1.3 g/cm³, however, it depends on the composition of the waste. The material is UV resistant because of the included contamination. This material is resistant to intemperate weather without significant modification in its properties.

This matrix material can be considered as a final product that can be processed. However, its major application area is that it acts as a base material for preparing composite materials applicable in diverse areas. The composite material is produced from the matrix material according to the invention by adding filling materials. The filling material can be added in the course of the internal mixing, the final step of producing the matrix material. In this case the step of pressing and cooling the matrix material without filling material is missing, and it is the composite material with the filling material that is pressed and cooled. In principle and also in practice it is also possible that the base material of the composite material is prefabricated matrix material block. However, in this case it must be melted before adding the filling material, and the filling material can be added to this melted matrix material. However, this requires significant further heating, causing extra expenses that is unacceptable with this inexpensive product.

As regards the final products of the method, differentiation is made between the pure material (free of filling materials), which is referred to as matrix material so as to make a distinction, and the material containing filling material, which is obtained from the pure matrix material by adding filling materials, and this is referred to as composite material. Nearly any kind of filling material can be used for the production of the composite material that is both physically and chemically compatible with the matrix material. The only requirement in connection with the resulting composite material is that it must not be harmful to the environment.

Some examples of filling materials are given. The list is not intended to be complete, and without restricting our invention to them: organic materials, primarily agricultural and manufacturing industrial materials, such as paper wastes and leather wastes (except those treated with chromium),—inorganic industrial wastes, such as tire granulate, cord fibers originating therefrom, steel rim wastes mixed with rubber, scrap glass (even if colored), and especially thermosetting plastics, wastes of printed circuits and electronic equipment that can not be used elsewhere,—mineral materials such as earth, brick dust, pebbles, crushed rocks, granite, limestone, marble, andesite, but especially brick dust.

Looking at the list of filling materials, one can see both that it is not the only important point that the composite material should be technologically suitable, but also that further harmful materials from the industrial and communal waste should be eliminated and transformed into valuable product in the course of the processing.

The matrix, that is, the product with no filling materials, can be widely used in itself as well. A non complete list of the possible areas of application is provided. It can be used as wood substitute base material, e.g. as base material of shutters, temporary fences, timber boards in construction industry, base material of park materials such as benches, fences or props, hydraulic engineering and road-building materials. Base material of water-resistant floors, coatings of heat and electrical insulations, protection of dams against rodents, flood control sheets and rods. In general it can be stated that this material can be widely used to substitute for wood, protecting forests, using wastes for valuable purposes.

The composite materials with the filling materials can be used essentially in the same areas. The filling materials modify the properties of the original matrix material. The filling material to be used depends on the actual application, and it is to be determined experimentally for the given application.

In the above, the methods and the steps of the methods are presented in detail, and the materials obtained by the method are characterized. In what follows, some special embodiments are presented as examples. However, these embodiments are presented for the purpose of demonstration only, and they shall by no means restrict the scope of the present invention.

### EXAMPLE 1

Industrial waste originated from a plant, containing 55% polyethylene, 25% polypropylene, 10% polypropylene cord and 10% inorganic waste is inputted into the recovering machine, the inputted material is heated and pressed by 2.4×10⁷ Pa (240 kg/cm²), and the material melted at 240° C. is transferred into the internal mixing machine. The matrix end product is obtained in the internal mixing machine where it is heated to 250° C. This matrix end product is extracted from the mixing machine, and the material of 220-240° C. is placed into a press providing the final form, where the material is cooled down under pressure in the closed press, and obtains its final form.

### EXAMPLE 2

The method is similar to the one presented in example 1, but the temperature in the recovering machine is 160° C. and the composition of the base material is 55% polyethylene packaging material, 5% polypropylene, 10% paper, 5% polyethylene bottle, 5% inorganic waste and 5% other organic waste. That is, the melting point of the plastic content of the waste is lower.

### EXAMPLE 3

The method is similar to the one presented in example 1, but the pressure applied in the recovering machine is 0.5×10⁷ Pa (50 kg/cm²), and the composition of the base material is 25% polyalkylene shrink-wrapping, 15% polyethylene, 10% PVC cover waste and 50% big-bag sack polypropylene. That is, the melting point of the plastic content of the waste is lower.

### EXAMPLE 4

The method is similar to any of the examples 1-3, but with added miscellaneous agricultural waste as filling material in an amount corresponding to 25% of the mass of the melted material in the internal mixing machine. The process is otherwise similar to the one presented in example 1.

### EXAMPLE 5

The mass composed in the internal mixing machine contains 15% polypropylene strips, 20% polyamide, 10% polyalkylene shrink-wrapping and 50% rubber scrapings or granulate as filling material.

### EXAMPLE 6

The mass composed in the internal mixing machine contains 3% polypropylene, 2% polyamide, 5% PVC and 7% polyethylene as matrix material, and 83% rubber scrapings as filling material. This material can preferably be used for manufacturing rubber bricks.

### EXAMPLE 7

The mass composed in the internal mixing machine contains 15% polyethylene, 15% polypropylene, 2% PVC and 8% polyamide as matrix material, and 60% crushed pebbles or breakstone as filling material.

### EXAMPLE 8

Sheets of 1 m² size and 20 mm thickness are produced from the matrix mass product obtained in any of examples 1-3 with a suitable shaping device.

### EXAMPLE 9

Flower-holder boxes of 500×200 mm size and 10 mm wall thickness are produced from the plastic matrix mass product obtained in any of examples 1-3 with a suitable shaping device.

### EXAMPLE 10

Sheets of 1 m² size and 20 mm thickness are produced from the plastic composite material containing filling materials obtained in example 4 with a suitable shaping device.

### EXAMPLE 11

Flower-holder boxes of 500×200 mm size and 5 mm wall thickness are produced from the plastic matrix mass product obtained in example 2 with a suitable shaping device.

### EXAMPLE 12

Euro-pallets are produced by the method according to example 1, where the matrix material contains 15% polyethylene, 20% polypropylene, 5% PVC and 10% polystyrene, and the filling material is 50% miscellaneous agricultural waste.

### EXAMPLE 13

The method according to any of examples 1-3, where 50% brick dust is added to the matrix material as filling material.

### EXAMPLE 14

Border-stones with rounded edges used at playgrounds are produced from the composite material according to example 6.

It is a further advantage of the final product that it can be welded with the same material or with the matrix material. It facilitates manufacturing and application of further products.

1-32. (canceled)

33. A method for producing matrix material from thermoplastic waste originating from communal and industrial rubbish with one of, (a) melting of the waste and transferring the melted plastic material to a homogenizing machine, and (b) melting of the waste and transferring the melted plastic material to a homogenizing machine with making-up of the melted material, the method further comprising:
inputting communal and industrial rubbish into a recovery machine equipped with heat transfer surfaces without selection, primary cleaning, chopping or shredding, impurely and in dry condition, where the plastic content of the rubbish mostly becomes a largely melted, nearly homogenous mixture by the help of the simultaneous effect of pressure and heat transmitted to the material where said pressure is between 0.5×10⁷ Pa and 2.5×10⁷ Pa and a heating temperature is between 200° C. and 280° C.; and
transferring the largely melted mixture into a heated internal mixing machine at a temperature between 200° C. and 260° C. without extrusion where complete melting and homogenization is carried out by the help of intensive mixing and heat transmission but without any of at least one of networking material and networking treatment, wherein a matrix material is obtained.

34. The method of claim 33 further comprising inputting the dry waste at a temperature between 20° C. and 50° C. into the recovery machine.

35. The method of claim 33 wherein said pressure is 1.2×10⁷ to 1.6×10⁷ Pa.

36. The method of claim 33 wherein said heating temperature is between 240° C. and 280° C.

37. The method of claim 33 further comprising inputting the largely melted material leaving the recovery machine into the internal mixing machine at a temperature between 250° C. and 270° C.

38. The method of claim 33 further comprising forming a pressed product from melted matrix material originated in the internal mixing machine by heat and pressure.

39. A method for producing composite material from the matrix material produced according to claim 33 with suitable filling material but without, at least one of, any networking material and networking treatment, wherein the filling material is added to the melted matrix material, and the composite material final product is obtained by mixing and heating.

40. The method of claim 39 further comprising cooling under pressure the molded product.

41. The method of claim 39 further comprising inputting organic material as filling material.

42. The method of claim 39 further comprising inputting agricultural and manufacturing industrial organic material as organic filling material including leather wastes.

43. The method of claim 39 further comprising inputting inorganic material as filling material.

44. The method of claim 39 further comprising inputting at least one of car tire granulate including cord fibers, wastes of steel rims treated with rubber or glass, and thermosetting plastic scrapings as inorganic industrial waste filling material and inputting at least one of earth, brick dust, pebbles, crushed rocks, granite, limestone and andesite as mineral filling material.

45. Composite material produced from matrix material according to the method of claim 39, comprising from 10% to 95% unclean inorganic waste as filling material including at least one of earth, metal, and crushed mineral material, crushed brick, stone, granite, limestone, marbles and andesite.

46. The method of claim 33, further comprising forming pressed material from the matrix material.

47. A method for producing composite material from the matrix material produced according to claim 33 with suitable filling material but without, at least one of, any networking material and networking treatment, wherein the filling material is added to the melted matrix material, and the composite material final product is obtained by mixing and heating, and, forming a final product by pressing to achieve a molded product of a required shape.

48. A matrix material produced by the method of claim 33.

49. An apparatus for utilization in a method for producing matrix material from thermoplastic waste originating from communal and industrial rubbish with one of, (a) melting of the waste and transferring the melted plastic material to a homogenizing machine, and (b) melting of the waste and transferring he melted plastic material to a homogenizing machine with making-up of the melted material, the apparatus comprising:
a recovery machine configured for inputting communal and industrial rubbish into the recovery machine, the recovery machine equipped with heat transfer surfaces without selection, primary cleaning, chopping or shredding, impurely and in dry condition, where the plastic content of the rubbish mostly becomes a largely melted, nearly homogenous mixture by the help of the simultaneous effect of pressure and heat transmitted to the material where said pressure is between 0.5×10⁷ Pa and 2.5×10⁷ Pa and a heating temperature is between 200° C. and 280° C.; and
a heated internal mixing machine configured for transferring the largely melted mixture into the heated internal mixing machine at a temperature between 200° C. and 260° C. without extrusion where complete melting and homogenization is carried out by the help of intensive mixing and heat transmission but without any of at least one of networking material and networking treatment, wherein a matrix material is obtained from the apparatus.

50. A pressed product obtained from the apparatus of claim 49.
